(19) United States
(12) Patent Application Publication
(10) Pub. No.: US 2015/0046194 A1
(43) Pub. Date: Feb. 12, 2015

(54) SYSTEM AND METHOD FOR USING CROWD SOURCED DATA FOR INSURANCE CLAIMS BASED ANALYSIS

(71) Applicant: Hartford Fire Insurance Company, Hartford, CT (US)

(72) Inventors: Brian D. Waddell, West Hartford, CT (US); Derrick J. Karle, Wallingford, CT (US)

(73) Assignee: Hartford Fire Insurance Company, Hartford, CT (US)

(21) Appl. No.: 13/961,203

(22) Filed: Aug. 7, 2013

(51) Int. Cl. G06Q 40/04

(52) U.S. Cl. CPC G06Q 40/04
USPC 705/4

(57) ABSTRACT

A crowd sourced based system for evaluating catastrophe areas for insurance entities and insureds. The system leverages crowd sourced photo data to construct a virtual map in real time corresponding to an afflicted area. User provided photo information as well as other third party information may be utilized to supplement the virtual map. A number of insurance based processes and actions may be based on an evaluation of the virtual map.

### BACKGROUND

Catastrophes caused by natural disasters such as earthquakes, floods, tsunamis, snowstorms, hurricanes and terrorist attacks result in billions of dollars of losses each year. Insurance can provide for protection for many of these catastrophes and insurance companies generally have many procedures for handling these tragic events. A large part of responding to such a catastrophe involves the insurance company evaluating and assessing damage, performing site visits for insurance adjusting and estimating and claims personnel staffing. Traditional methods for catastrophe mapping and claims response generally rely heavily on forecasted models. For the most part, the insurance company will not know the extent of the damage in an area until claims personnel can travel to the location and perform analysis. Many times access points to these affected areas are often impaired and obstructed, making it difficult for these assessments to occur. As a result, there is a significant time gap between the data in the insurance company's forecasted models and when ground-level data from claims teams is available to plan for damage assessment and claims response actions.

Speed of damage assessment and claims response is a critical factor and performance component of any insurance company, and is one of the leading indicators used by firms such as J.D. Powers & Associates in ranking insurance carrier performance. Generally, it can take many days and even weeks before claims personnel could reach damaged areas after a catastrophe event. Currently, use of satellites to evaluate afflicted areas may not provide the most current data as it may take days between satellite passes. Furthermore, weather patterns can linger over weather related catastrophes for days, which can reduce the usefulness of the satellite imagery.

Accordingly, it would be desirable to have a system that could provide insurers and consumers with real time, accurate and timely data during and after catastrophes to speed damage assessment, claims response, adjusting and eventual settlement with the insureds. Such a system would benefit both the insurers and the insureds greatly by expediting the claims process by both sides during a catastrophe.

### SUMMARY

The present invention in some embodiments relates to, a system for intelligently compiling and assessing pictorial based data for insurance claims operations, the system comprising at least one processor; a memory coupled to the at least one processor; and one or more programs, wherein the one or more programs are stored in the memory and configured to be executed by the at least one processor, the one or more programs including instructions for: segmenting a selected geographic location into a plurality of regions to form a virtual pictorial mapping of one or more insured properties; accessing crowd sourced based pictorial data for each of the plurality of regions; compiling the crowd sourced based pictorial data into the virtual mapping by correlating location based information associated with the pictorial data to the virtual mapping; determining if one or more gaps exist within the virtual mapping; accessing pictorial data for the one or more gaps; associating the accessed pictorial data to the one or more gaps; evaluating the virtual mapping to determine an insurance based action related action; and issuing a communication to an insurance claims system related to the evaluation of the virtual mapping.

In other embodiments, the invention relates to a computer program, comprising a computer usable medium having a computer readable program code embodied therein, said computer readable program code adapted to be executed to implement a method for assessing catastrophe damage in an afflicted geographic area, said method comprising: dividing an area into a plurality of photo regions to form a virtual area map; receiving crowd sourced digital images; assigning the digital images to one or more regions on the virtual area map; determining if one or more regions require data supplementation; acquiring additional image data for the regions requiring data supplementation; evaluating the virtual area map to form an insurance recommendation; and transmitting data to a insurance entity system related to the insurance recommendation.

In other embodiments, the invention relates to a computer-implemented method for intelligent automated catastrophe site evaluation comprising: segmenting a selected geographic location into a plurality of regions to form a virtual pictorial mapping; accessing crowd sourced based pictorial data for each of the plurality of regions; compiling the crowd sourced based pictorial data into the virtual mapping by correlating location based information associated with the pictorial data to the virtual mapping; determining if one or more gaps exist within the virtual mapping; requesting pictorial data for the one or more gaps; associating the requested pictorial data to the one or more gaps; evaluating the virtual mapping to issue an insurance based alert message; and transmitting the alert message to a policyholder device

### BRIEF DESCRIPTION OF THE DRAWINGS

A more detailed understanding may be had from the following description, given by way of example in conjunction with the accompanying drawings wherein:

FIG. 1 shows an exemplary computer architecture that may be used for catastrophe data administration and management;

FIG. 2 shows an exemplary system that may be used for the management of catastrophe data;

FIG. 3 shows exemplary system screen display of the present invention;

FIG. 4 shows exemplary system screen display of the present invention;

FIG. 5 shows exemplary system screen of the present invention;

FIG. 6 shows exemplary method of the present invention;

FIG. 7 shows another exemplary device of the present invention;

FIG. 8 shows an exemplary screen display of the present invention;

FIG. 9 shown an exemplary layout of a virtual mapping of the present invention.

### DETAILED DESCRIPTION

Disclosed herein are processor-executable methods, computing systems, and related technologies for the processing and analysis of crowd sourced data for administration and management of catastrophe related insurance claims. The ability to quickly and efficiently manage enormous catastrophes, while simultaneously keeping conventional day-to-day claims serviced, is critical for a property and casualty insurance company. When properly handled, a catastrophe claim can demonstrate to the policyholders and the public the true value of insurance. During a catastrophe, the insurance company needs to quickly determine the scope and extent of the catastrophe and how to handle and service policyholders and how to evaluate insured properties within the catastrophe. Many issues will arise such as how a catastrophe team will be staffed especially since the physical environment of the catastrophe will present a logistic and practical challenge to a catastrophe team member such as insurance adjusters. The damages to property will be many and varied, requiring skill and ingenuity in many instances to estimate the scope of the loss and calculate and negotiate the various insurance settlements for the insureds' properties.

In today's mobile technology environment, there is an increased level of photo activity as people document catastrophe damage to share with others, for example, pictures uploaded to social media sites/channels or news sites. Generally many people take digital pictures with their camera phones or similar devices and post them on electronic social networking or social media sites like Twitter, Facebook, Instagram, Google+, etc. These photos are generally taken with mobile devices such as smartphones which embed geographic information system (GIS) data or any type of methodology or system designed to capture, store, manipulate, analyze, manage, and present all types of geographical data, which may be referred to herein as “geocoded data” or “location based data,” related to each photo. By combining the crowd sourced photos having geocoded data and geographical data, such as GIS data for locations of insured properties, a new and powerful “virtual ground-level walk-thru” of catastrophe areas may be constructed in embodiments of the present invention by intelligently and selectively overlaying the crowd sourced photos over the geocoded data of the insureds' properties and over geocoded data relating to roads, utilities and other facilities.

With this overlaying or mapping the insurance company can more accurately deploy claims resources to those geographical areas that are hardest hit, and can even guide claims resources to those geographical areas, particular properties in geographical areas, locations and around road hazards. With embodiments of present invention, initial claims teams can perform initial intelligence gathering from a centralized location, allowing the insurance company's claims teams to focus on working with insureds on claims, and providing a good claims experience. Insurance companies can proactively reach out to insureds to assess their condition based on photos collected having geocoded data matching or near locations of insured properties, instead on waiting for insureds to contact the insurance company. Utilizing embodiments of the present invention, the insurance company can quickly assess total insurance and operational risk exposure from a realized catastrophe event, allowing enterprise risk management teams to re-allocate financial assets for claims in a more timely manner. Insurance companies can also provide claim advances to insureds within hours of the storm or other catastrophe, providing them with resources for shelter and emergency food based on an assessment of photos from their immediate area. The virtual maps of embodiments the present invention may also be shared with Federal and State emergency responders for use in disaster response, or with the public for use allowing the identification of family and friends in the impacted area. Additionally, timestamps in photos would allow for “time-lapse” maps of areas, which would be useful in future catastrophe modeling to determine how certain areas react to certain types of catastrophic events.

The term “crowd-sourced” as used herein means, for data, data that is collected in a process of obtaining the data from members of a group or the general public, either in response to a request or by obtaining data from one or more repositories of data. The crowd sourced data is generally obtained from a large number of individual providers of data. The providers are not necessarily requested in advance to provide the data. The persons requested to provide the data may exclude, or include primarily persons other than, those with an existing business arrangement with the insurance company, such as insurance company employees, contractors, agents, policy holders, adjusters and the like.

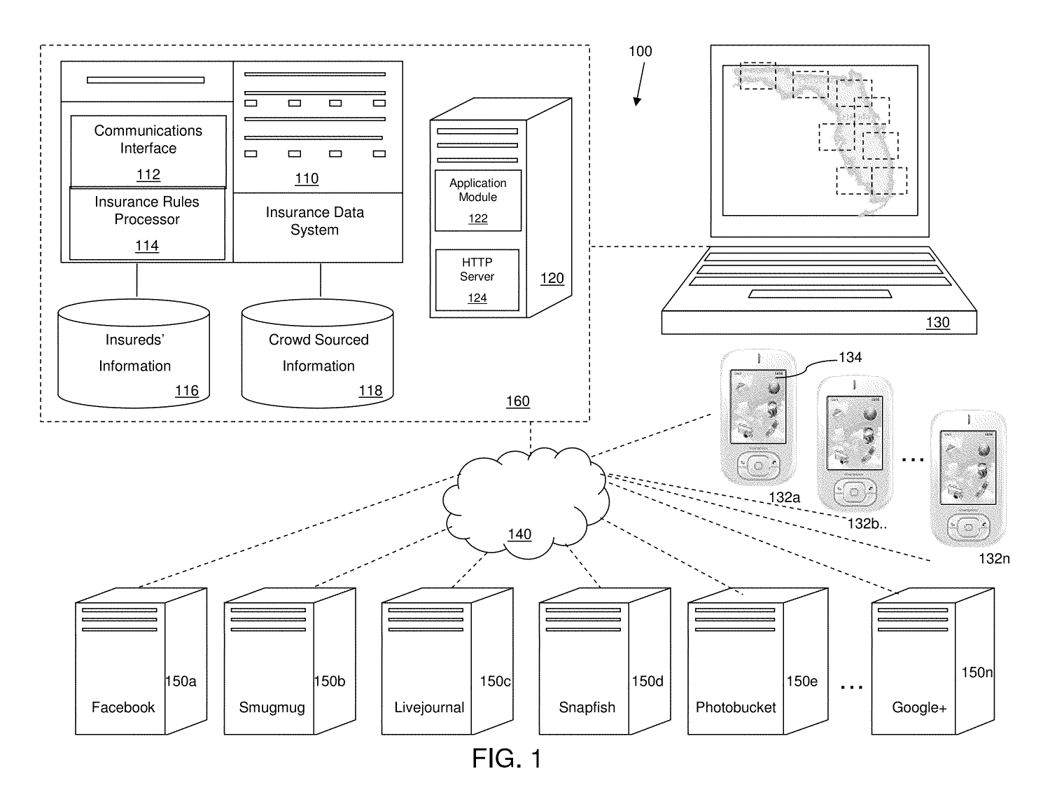

FIG. 1 shows an example system architecture 100 that may be used for the administration and management of catastrophe claims using crowd sourced data merged with insurance company insureds' data. The example architecture 100 includes an insurance data system 110, a web system 120, an insurance terminal 130, user devices 132a-n, a network 140, and a plurality of third party web based systems 150a-n. Insurance data system 110 may include a communications interface 112, an insurance rules processor 114, an insureds information database 116 and crowd sourced information database 118 that comprise an insurance company subsystem 160. In one embodiment, insurance terminal 130, user devices 132a-n, third party web based systems 150a-n and insurance company subsystem 160 are in communication via a network 140. Insurance company subsystem 160 shown in FIG. 1 is an embodiment of a subsystem that might be implemented solely within the corporate office headquarters of a financial services/insurance company or be an aggregation of one or more other subsystems including one or more partner, third party administrator and/or vendor subsystems to allow communications and data transfer between the insurance company and claims representatives, adjusters, insurance customers, and insurance agents. Data transferred through network 140 to insurance subsystem 160 may pass through one or more firewalls or other security type controls implemented within web system 120 and/or in standalone devices. The firewall allows access to network 140 only through predetermined conditions/ports. In another embodiment, the firewall restricts the Internet IP addresses that may access web system 120.

In operation, insurance subsystem 160 may implement spider/webcrawler technology to search via network 140 for data such as crowd sourced pictorial data in the form of digital photographs and associated location based information on third party web systems 150a-n that have been uploaded to third party web systems 150a-n by a plurality of third parties. Insurance subsystem 160 may also communicate with user devices 132a-n to obtain data such as digital photographs and associated geocoded data directly from one or more users.

Referring to FIG. 1 still, insurance rules processor 114 may include one or more business rules and one or more predictive models in conjunction with one or more software modules or objects and one or more specific-purpose processor elements to perform the processing required by embodiments of the present invention such as for selecting a geographic area that constitutes a catastrophe site for analysis, accessing from crowd sourced pictorial data portions of the pictorial data that matches catastrophe site geographic area definitions and matching selected crowd sourced pictorial data to select data such as pictures and associated geographic identifiers with insureds' property and location information as well as for predicting levels of damages in affected areas.

The insureds' information database 116 may store information, data and documents that relate to insureds' policies such as home, business and/or automobile related policy information as well as location information. Crowd sourced information database 118 may store information, data and documents from user devices 132a-n and third party systems 150a-n. Insureds' information database 116 and crowd sourced information database 118 may be spread across one or more computer-readable storage media, and may be or include one or more relational databases, hierarchical databases, object-oriented databases, one or more flat files, one or more spreadsheets, and/or one or more structured files. Insureds' information database 116 and crowd sourced information database 118 may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology.

Communication between the insurance data system 110 and the other elements in the example architecture 100 of FIG. 1 may be performed via the communications interface module 112 interacting within insurance data subsystem 160. The insurance data subsystem 160 may access and communicate with user devices 132a-n and third party systems 150a-n via communications interface 112.

Referring still to FIG. 1, web system 120 may provide a web interface that may be accessed directly by a user such as an insured, a claims representative, an insurance adjuster and other third party entity employing user devices 132a-n to communicate and interact with an insurance company representative employing terminal 130. In certain embodiments, user devices 132a-n and terminal 130 can include, but are not limited to cellular telephones, other wireless communication devices, personal digital assistants, pagers, laptop computers, tablet computers, smartphones, other mobile display devices, or combinations thereof. In embodiments of the present invention, devices 132a-n and terminal 130 may communicate with the web site system 120 that may be operated by or under the control of an insurance entity or other third party entity such as an outsourced type entity or third party administrator type entity. The web site system 120 may generate one or more web pages for access by client devices 132a-n and requesting user device 132, and may receive responsive information from client devices 132a-n such as certain requested coverage and policy information. The web site system 120 may then communicate this information to the insurance data system 110 for processing via communications interface 112.

In operation, devices 132a-n and terminal 130 may be used to update insureds about the status of their claim, condition of their property, provide payments and settlements, and other claims related activities. The web site system 120 may include a web application module 122 and a HyperText Transfer Protocol (HTTP) server module 124. The web application module 122 may generate the web pages that make up the web site and that are communicated by the HTTP server module 124. Web application module 122 may be implemented in and/or based on a technology such as Active Server Pages (ASP), PHP: Hypertext Preprocessor (PHP), Python/Zope, Ruby, any server-side scripting language, and/or any other appropriate technology.

The HTTP server module 124 may implement the HTTP protocol, and may communicate HyperText Markup Language (HTML) pages and related data from the web site to/from client devices 132a-n and 130 using HTTP. The HTTP server module 124 may be, for example, a Sun-ONE Web Server, an Apache HTTP server, a Microsoft Internet Information Services (IIS) server, and/or may be based on any other appropriate HTTP server technology. The web site system 120 may also include one or more additional components or modules (not depicted), such as one or more switches, load balancers, firewall devices, routers, and devices that handle power backup and data redundancy.

Referring still to FIG. 1, one or more of the client devices 132a-n such as client device 132a may include a web browser module 134, which may communicate data related to the web site to/from the HTTP server module 124 and the web application module 122 in the web site system 120. The web browser module 134 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 134 may implement Rich Internet Application (RIA) and/or multimedia technologies such as Adobe Flash, Microsoft Silverlight, and/or other technologies. The web browser module 134 may implement RIA and/or multimedia technologies using one or web browser plug-in modules (such as, for example, an Adobe Flash or Microsoft Silverlight plugin), and/or using one or more sub-modules within the web browser module 134 itself. The web browser module 134 may display data on one or more displays that are included in or connected to the client device 132a, such as a liquid crystal display (LCD) display, organic light-emitting diode (OLED) display, touch screen or monitor. The client device 132a may receive input from the user of the client device 132a from input devices (not depicted) that are included in or connected to the client device 132a, such a mouse or other pointing device, or a touch screen, and provide data that indicates the input to the web browser module 134.

The example architecture 100 of FIG. 1 may also include one or more wired and/or wireless networks within subsystem 160 via which communications between the elements and components shown in the example architecture 100 may take place. The networks may be private or public networks, cloud or shared networks and/or may include the Internet.

Each or any combination of the components/modules 112, 114, 122, and 124 shown in FIG. 1 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules 112, 114, 122, and 124 may perform functionality described later herein.

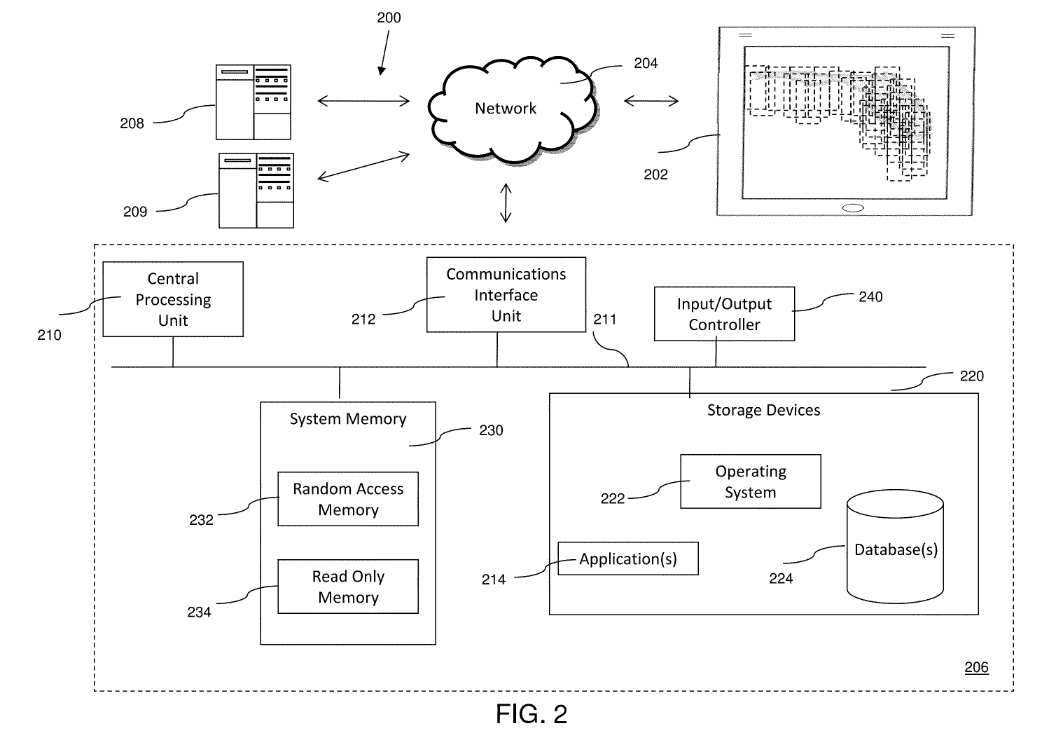

Referring to FIG. 2, an exemplary computer system 200 for use in an implementation of the invention will now be described. Computer system 200 may be configured to perform catastrophe claims evaluation and management for one or more insurance companies and their associated agents, personnel, customers and staff using devices 202. System 200 may include device 202, which may be an insurance company terminal or device, a network 204, an insurance processing and data system 206 and one or more third party servers 208 and 209. In embodiments of the present invention, insurance processing and data system 206 is responsible for the processing of catastrophe related data such as image and text data, including crowd sourced based pictorial data, from third party servers 208 and 209 to combine such data with insured customer information in order to make claims related decisions. In insurance processing and data system 206, a central processing unit or processor 210 executes instructions contained in programs such as policy management application program 214, stored in storage devices 220. Processor 210 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 220 may include suitable media, such as optical or magnetic disks, fixed disks with magnetic storage (hard drives), tapes accessed by tape drives, and other storage media. Processor 210 communicates, such as through bus 211 and/or other data channels, with communications interface unit 212, storage devices 220, system memory 230, and input/output controller 240. System memory 230 may further include non-transitory computer-readable media such as a random access memory 232 and a read only memory 234. Random access memory 232 may store instructions in the form of computer code provided by application 214 to implement the present invention. One or more computer programs may be stored in memory, or computer usable media, such as storage devices 220 and random access memory 232, in the form of computer readable program code adapted to be executed by at least one processor, such as a processor central processing unit 210. The one or more computer programs may include instructions for performing steps of methods of embodiments of the invention described herein. System 200 further includes an input/output controller 240 that may communicate with processor 210 to receive data from user inputs such as pointing devices, touch screens, and audio inputs, and may provide data to outputs, such as data to video drivers for formatting on displays, and data to audio devices.

Storage devices 220 are configured to exchange data with processor 210, and may store programs containing processor-executable instructions, and values of variables for use by such programs. Processor 210 is configured to access data from storage devices 220, which may include connecting to storage devices 220 and obtain data or read data from the storage devices, or place data into the storage devices. Storage devices 220 may include local and network accessible mass storage devices. Storage devices 220 may include media for storing operating system 222 and mass storage devices such as storage 224 for storing data related to catastrophe data, insured customer information and claims related data and information such as claim advance and settlement data.

Communications interface unit 212 may communicate via network 204 with other computer systems such as third party servers 208 and 209 as well as other internal and external servers, computer systems of remote sources of data, and with systems for implementing instructions output by processor 210. Insurance processing and data system 206 may also be configured in a distributed architecture, wherein databases, data storage devices and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. Network 206 may be or include wired or wireless local area networks and wide area networks, and over communications between networks, including over the Internet.

One or more public cloud, private cloud, hybrid cloud and cloud-like networks may also be implemented, for example, to handle and conduct processing of one or more transactions or processing of the present invention. Cloud based computing may be used herein to handle any one or more of the application, storage and connectivity requirements of the present invention. For example one or more private clouds may be implemented to handle catastrophe data and crowd sourcing data of the present invention. Furthermore, any suitable data and communication protocols may be employed to accomplish the teachings of the present invention.

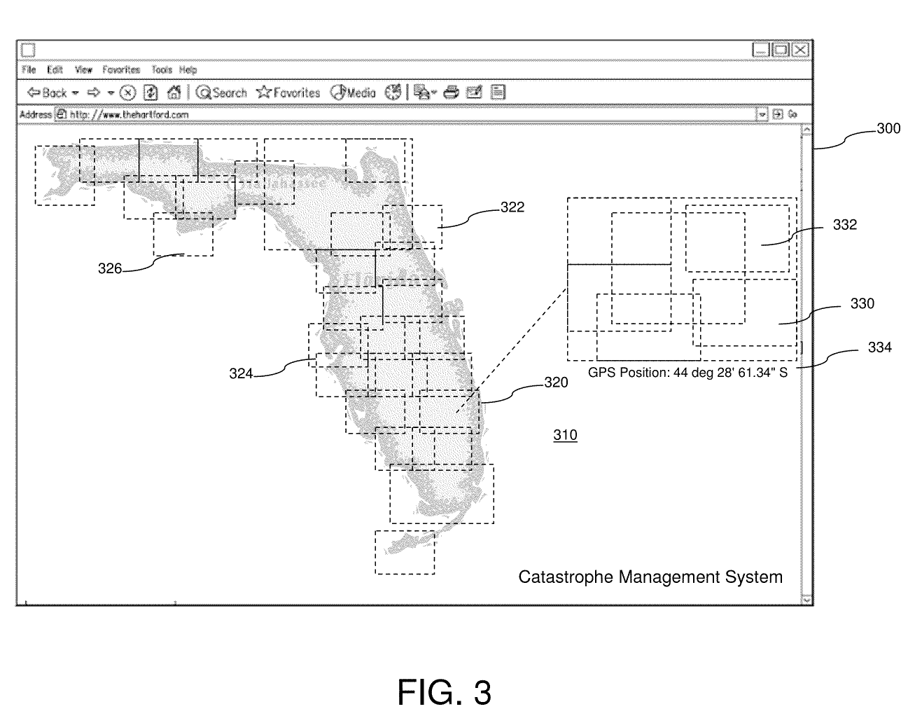

FIG. 3 illustrates an exemplary screen configuration 300 of an insurance catastrophe management system as discussed with respect to FIGS. 1 and 2. Screen 300 is configured to interface with a requesting user such as an insurance company employee for administering and managing claims related to catastrophic events. Screen 300 includes a visual representation 310 of a geographic area that is arranged or segmented into a plurality of subparts, regions or segments 320, 322, 324 and 326 to form a virtual pictorial mapping of one or more areas containing one or more insured properties such as residential and/or commercial properties. For example, in the embodiment of FIG. 3, a system may be configured to identify a geographic location at a state level, and the system may have determined, based on received weather and/or damage data from one or more sources, that the State of Florida is identified as a geographic area afflicted by a catastrophe. The arranging or segmenting may be implemented by any one of a number of algorithms, such as algorithms that define a region based on geographic extent by such parameters as maximum, minimum or target square miles or acreage, target, maximum or minimum numbers of insured properties, target, maximum or minimum population figures, or other algorithms. Each segment or region such as region 320 may be further segmented or divided into further or additional sub-regions or sub-segments such as subregions 330 and 332, using similar algorithms. In one embodiment, each region or sub-region may represent one or more insured properties identified or bound by one or more geographic identifier such by geographic coordinates, locators or other identifiers 334. In embodiments, less than all of a geographic area may be included in a region; by way of example, portions of a geographic area containing no insured properties may not be included in any region; similarly, portions of any smaller subdivision may not be included in a still further subdivision if no insured properties are located in the still further subdivision. In operation, system 206 shown in FIG. 2 may be implemented to automatically to search and locate photo data for graphically populating the regions within visual representation 310. For example, certain web crawling and scraping technology may be employed on the web for searching for crowd sourced based pictorial data such as photos uploaded from a plurality of mobile devices after a catastrophic event, and using the GIS meta-data contained in each photo to overlay each photo into the appropriate segment or sub-segment. The searching for crowd sourced pictorial data may be conducted for each of the regions, as a whole or on a region-by-region basis. Crowd sourced pictorial data may be collected, and then digital images of the crowd sourced pictorial data may be assigned to one or more regions or subregions by correlating location based information associated with the digital images with location based identifications of regions or subregions.

Photos utilized in the present invention generally may be geocoded or geotagged. Geotagging results in the photo having accessible geographical identification metadata that usually consists of latitude and longitude coordinates, as well as altitude, bearing, distance, accuracy data, and place names. Geotagging can assist in the present invention by have the insurance subsystem search for images taken near a given catastrophe location by entering latitude and longitude coordinates into a suitable image search engine. Location identification may also include geocoding or using non-coordinate based geographical identifiers, such as a street address, name of a business, non-profit, facility, individual or landmark associated with the location and finding associated geographic coordinates for the photos or pictorial data in the present invention.

Generally, pictorial data or photos may be accessed and stored in a variety of formats including the JPEG file format where the geotag information will be typically embedded in the metadata stored in Exchangeable image file format (EXIF) or Extensible Metadata Platform (XMP) format. Location information such as latitude and longitude may be stored in units of degrees with decimals, such as in the form of global positioning coordinates, such as Global Positioning System (GPS) Latitude: 68 deg 48′ 66.73″ S; GPS Longitude: 12 deg 35′ 26.74″ W; GPS Position: 44 deg 28′ 61.34″ S, 11 deg 34′ 36.70″ E or alternatively location information could also be presented in formats such as: GPS Latitude 52.34512; GPS Longitude: 20.41736 and GPS Position: 47.65611 11.20233.

It is contemplated that each pictorial data or photo may be content analyzed by one or more algorithms for both content and/or quality. Certain features in the photo may be detected by such analysis to supplement the location based data so that the picture best encompasses one or more insured properties attributable to one or more insurers. The photos may also be ranked based on content and/or image quality especially where multiple photos may be accessible for the same general location. In such a ranking, the photos that best encompass the insured property and have the best image quality would be selected for the virtual mapping.

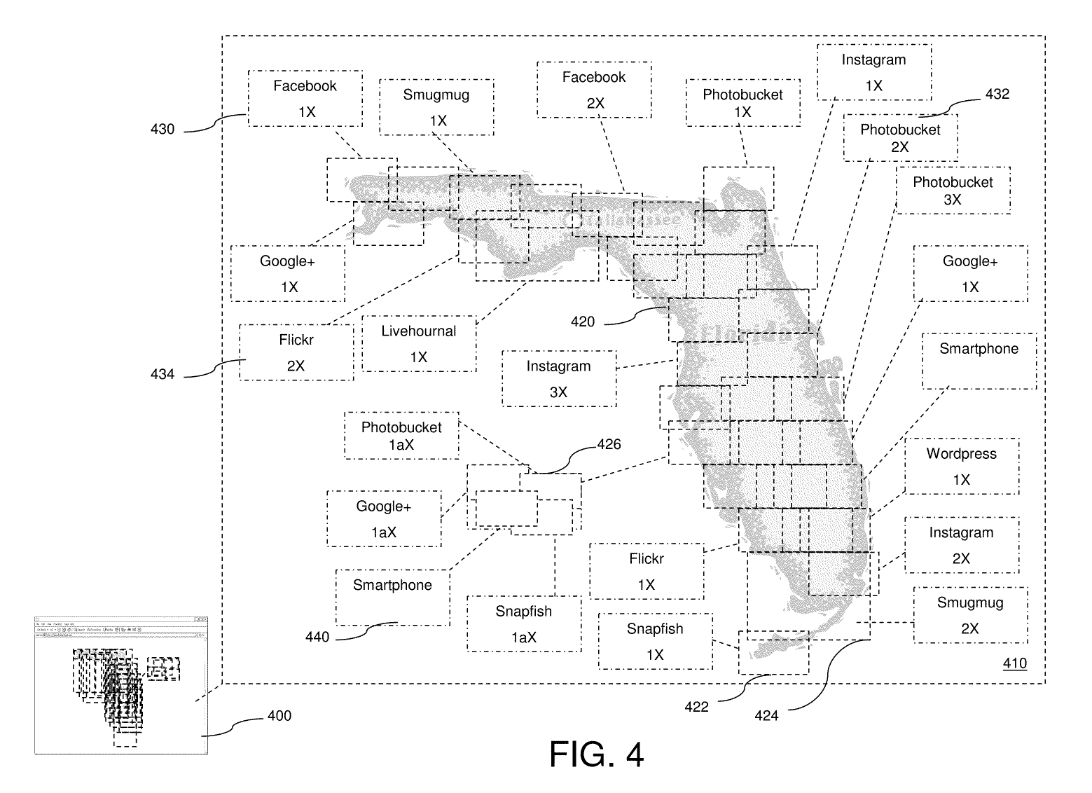

FIG. 4 illustrates an exemplary screen configuration 400 of an insurance catastrophe management system as discussed with respect to FIGS. 1 and 2. Screen 400 is configured to interface with a user such as an insurance company claims personnel for administering and managing claims related to catastrophic events. Screen 400 includes a display area 410 that provides a graphical representation 420 of a geographic area that is organized by geographical boundaries that define all or portions of customer insured properties such as sub segments or areas 422 and 424. Each segment or area may also be defined by smaller subsegments or areas 426. In operation, each area 422 and 424 may be overlaid or associated with photo data 430, 432 and 434. that corresponds to all or part of the customer insured properties. Matching algorithms or methodology may be used to correlate geographic information or location based information associated with the pictorial data, such as location information associated with a photo and geographic information associated with an area defining all or part of an insured property location. Photos may be from a plurality of sources such as Facebook, Photobucket, Flickr, Google+, Livejournal, Instagram, Snapfish, Smugmug, CNN IReport, Twitter, WikiNews, MSNBC FirstPerson, ABC i-Caught, FOX u-Report, OneNews.com, 360 News, Flickr, and YouTube. Additionally, additional photo data 440 may be received directly from insureds or other third parties via their respective mobile devices. These mobile devices may be configured with an application program or app that causes the mobile device to provide user prompts, such as in the form of fields on a screen display, for users to provide commentary/additional detail. The app may be configured to cause the mobile phone to automatically obtain satellite data, if available, and append GIS or other location data to photos. The app may be configured to be activated responsive to a communication sent to the mobile device, such as from an insurance company system, via text message, e-mail or otherwise. The app could be configured to be activated by the user, or may be configured to monitor data received by one or more applications, text messages or the like for activation. For example, the app may automatically activate responsive to receipt of text messages from emergency management personnel, weather application data indicative of tornado or hurricane warnings or other thresholds, or news application data indicating key words such as tornado, hurricane, flooding, wildfire associated with geographic indicators such as city, county, neighborhood, region or landmark names. The app could also alert the insured with for example, providing the user with an alert and allowing the user to view their own property based on crowd sourced pictorial data having location data correlated with property location data or provide a virtual walk-thru of their own neighborhood afflicted by the catastrophe. The photos may be made available via a link provided to the mobile device such as by web system 120 of FIG. 1.

Where GIS is unavailable for that device, the IP Address of the originating source, such as the mobile device will allow for mapping of the photo to the areas 422 and 424, or if image is from a mobile device such as in 440, location could be established by cell tower triangulation, based on triangulating the cellular towers used to submit the photo.

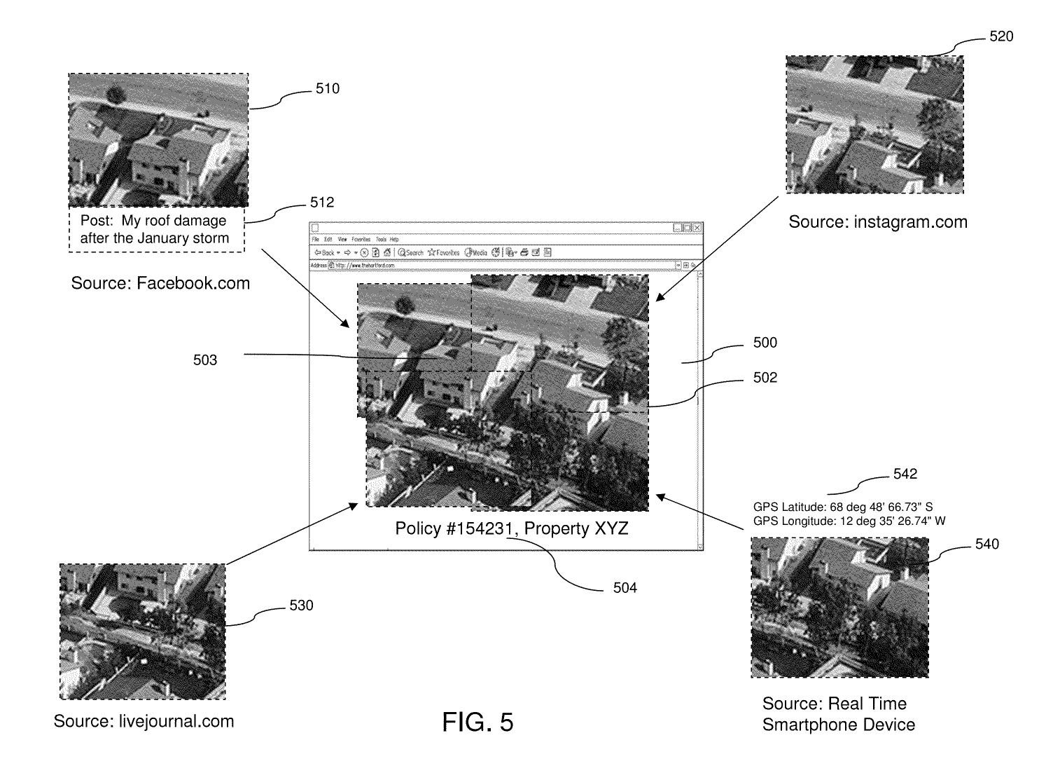

FIG. 5 illustrates another exemplary screen configuration 500 of an insurance catastrophe management system as discussed with respect to FIGS. 1 and 2. Screen 500 is configured to interface with a user such as an insurance company employee for claims management related to catastrophic events. Screen 500 includes a virtual mapping 502 of at least one insured property 503 that is identified by a policy number and/or address 504. In operation, one or more photos such as photos 510, 520, 530 and 540 are combined or compiled to form virtual mapping 502. It is contemplated that photos 510, 520, 530 and 540 may be butted up against one another, overlap or even form gaps in order to most accurately represent the area desired depending on the availability of photos that cover the desired area. In one embodiment, geographic identifiers or information associated with the photo may be matched with geographic identifiers or information associated with an insured's property to form virtual mapping 502. Additionally, content of the pictorial data may be analyzed in order to correlate a photo with location data. For example, photo recognition techniques that screen each incoming photo, assign a score indicative of likelihood of the photo representing, for example, a particular feature, building, or area or neighborhood, and allow accurate matching to a known area may also be used. In other embodiments, utilities maps that include one or more of power lines, water lines, sewer lines, etc may be combined or overlaid on virtual mapping 502 to provide a utility map overlap in the virtual pictorial mapping. Utility map data may include service update data, such as areas of power outages, gas outages or leak reports, water main breaks and other issues. In other embodiments, text algorithms (by way of example, searching for data such as street names, neighborhood names, landmarks, businesses, non-profits and the like to determine location, and text parsing for words indicating damage, such as “tree” within 3 words of “car” in more than a threshold number of photos in a region or sub-region or other geographic area) may be used to parse text in the comments loaded in the third party site and associated with user submitted photos 512 and provide additional insight and analysis as to the location of the photo and the condition and status of the insured property. Additionally, the photos such as photo 540 may have associated GIS related information such as Latitude and Longitude related metadata 542 that is utilized to properly overlay the photos onto insured property data. In embodiments, the system may augment the crowd sourced pictorial data with satellite based imagery, accessing satellite image data having geographic data associated with an insured property location or other location. In embodiments of the present invention, map overlay or the arrangement and storing of digital photo data in multiple layers is used to generate a new combined data layer as a product of existing layers of insured property data and crowd sourced photo data. Map overlay can be implemented in a variety of manner such as, for example, in a vector or a raster format. In the vector case, or polygon overlay, the intersection of two or more data layers produces new features where attributes of intersecting polygons are combined. The raster implementation also known as grid overlay may combine attributes within grid cells that align closely. Misaligned grids may be resampled to common formats. Additionally, edge matching techniques may be used to adjust the position of features extending across virtual map boundaries of insured property mappings so that relevant insured property features have the same edge locations.

In the present invention, photos forming the virtual mapping may also be periodically collected and time stamped to form a real time virtual mapping that can be compared to determine if any damage or change in damage, has occurred to one or more insured properties at certain instances in time. For example, on a periodic basis, systems may access social media sites and other sources of crowd based pictorial data, send requests for photos, and generate updated and time stamped real time mapping. The time stamped mappings may be stored and evaluated for changes in damage to insured properties.

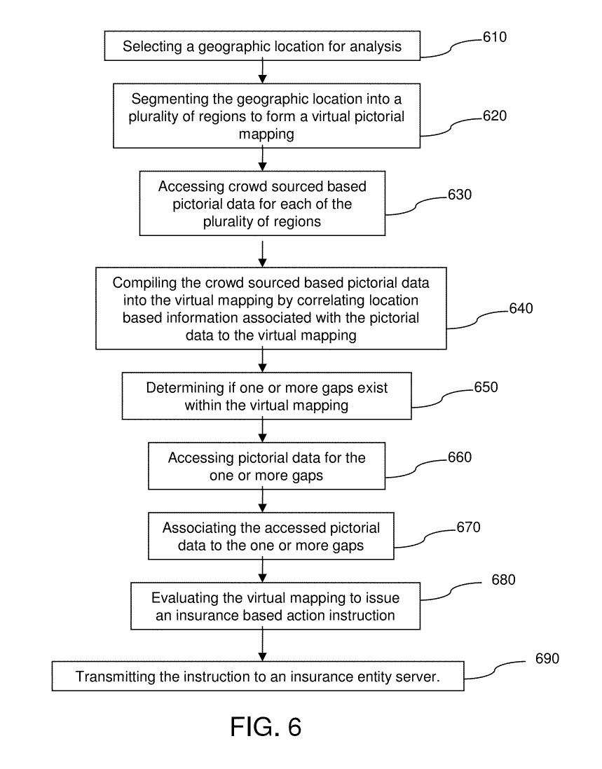

FIG. 6 illustrates an exemplary method for intelligent automated catastrophe site evaluation of the present invention. In one embodiment, the method involves selecting a geographic location for analysis, step 610. The location will generally correspond to one or more insured properties that have been involved with a catastrophe in order to assess damage and potential coverage under an applicable insurance policy. The geographic location may be defined by any suitable location data. An algorithm for selection of a geographic location involved with or afflicted by a catastrophe may include an algorithm using matching techniques between listings of locations of insured properties, on the one hand, and identifications, such as data from weather sources, news sources and social media, of a geographic extent of a catastrophe. The algorithm may include rules for selecting a geographic area around locations of insured properties in or near identified catastrophe locations, such as rules based on extent of political divisions, such as states, counties and municipalities, and rules based on distance from a nearest insured property, rules based on lines of longitude and latitude, and other rules providing suitable location data. The method continues with segmenting the geographic location into a plurality of regions to form a virtual pictorial mapping, step 620. Segmenting may include dividing and/or subdividing the location into smaller regions based on algorithms using as factors the locations of insured properties and the availability of crowd sourced photo data, and one or more thresholds for numbers of insured properties, geographic area and the like. The method continues by accessing crowd sourced based pictorial data for each of the plurality of regions, step 630. Pictorial data as well as text data from a variety of sites such as social network and photo repository sites may be used and accessed. Accessing crowd sourced pictorial data corresponding to each of the regions may include searching data sources for pictorial data having geographic data associated with the regions, obtaining pictorial data from data sources and using search techniques to identify pictorial data, such as particular pictures, matching regions, and other techniques. The method continues with compiling the crowd sourced based pictorial data into the virtual mapping by correlating location based information associated with the pictorial data to the virtual mapping, step 640. The method continues with determining if one or more gaps exist within the virtual mapping, step 650.

Gaps may occur where the available photo data does not completely cover the respective segment for the insured property or property. Gaps may be identified based on comparing insured property location data with pictorial data location data and determining a gap based on a threshold separation between nearest pictorial data location data and insured property location data. Other factors such as number of distinct photographs in a region, quality of photographs (e.g., lower quality value to lower resolution photographs or quality value depending on source of photographs), quality of geographic data (lower quality value to landmark or neighborhood based than to longitude/latitude based). Algorithms to identify gaps may include as factors a duration subsequent to a time of a most recent photograph showing an insured property; a gap may be identified if a duration subsequent to a time of a most recent photograph is above a threshold. The threshold may be a fixed threshold value stored in a memory device, or may be a variable threshold value determined based on received data or determined data values of catastrophe type (e.g., a shorter threshold time value for a tornado or derecho than for a tropical storm), geographic distance between an insured property and locations associated with weather reports, media reports and/or social media reports of damage or severe weather, which data may be accessed or received on an ongoing basis by one or more systems according to embodiments of the invention and analyzed for geographic data and text and image data indicating severe weather and property damage and/or conditions likely to result in property damage, such as flooding) and other factors. The time associated with a photograph may be obtained from metadata associated with the photograph and/or time data associated with an upload to or publication by a social media site or other site. A gap determination algorithm may also employ as factors particular sources of image data and types of image data sources. For example, a gap may be identified based on such factors as: (1) an absence of image data received directly from mobile devices; (2) image data received directly from image devices below a threshold, exemplary thresholds being a threshold number of images, or a threshold quality factor including number of images and a quality factor based on number of images depicting insured properties, quality of depiction of insured properties (e.g., percentage of image area depicting insured properties), geographic distance between images and insured properties, and other factors; (3) an absence of image data from one or more media sites, an absence of image data from one or more classes of media sites, or a quality value, determined based on factors as described above, associated with one or more media sites or classes of media sites, being below a threshold. The identification of gaps may be an example of a determination that one or more regions require data supplementation. Other determinations of data supplementation may be made based on assessments of quality of data for a region and comparing a quality score or scores to threshold scores, a quality score or scores being below a threshold indicating a requirement for data supplementation.

The method continues with accessing and/or acquiring pictorial data for the one or more gaps, or for regions and/or time periods determined to require data supplementation, step 660. The accessing and/or acquiring pictorial data for the one or more gaps or regions and time periods determined to require data supplementation may include requesting pictorial data, including requesting crowd-sourced pictorial data. Pictorial data may be requested from the insured, an insurance company representative or agent or any other third party entity that may have access to the area associated with the gap or the region determined to require data supplementation. The requesting may include sending an alert to an insured related to an insured property, issuing instructions to one or more users related to a geographical location corresponding to at least one region to one or more users, or otherwise. The alert or instructions may be communicated in any manner, including text message, e-mail, notification via one or more apps, such as one or more mobile phone based apps, notification via a social network or other resource used to collect data, or otherwise. Pictorial data or image data is then received in response to the request, such as by direct communication from recipients to the insurance company systems, and/or scraping data from social network sites associated with recipients of the request or from other resources. By way of example, a recipient of a request may pass the request to a third party who then uploads pictorial data to a different social network site from that used by the recipient of the request. In embodiments, data may be accessed or acquired without a request. For example, a search may be conducted of one or more data sources containing pictorial data, the search being conducted using search strategies directed to obtain pictorial data having associated location and/or time data corresponding to one or more identified gaps and/or one or more regions or time periods determined to require data supplementation.

The method continues with associating the received, accessed and/or acquired pictorial data, which may include requested pictorial data received and/or acquired in response to one or more requests, to the one or more gaps or regions requiring data supplementation, step 670. The associating the requested pictorial data may include overlaying the requested pictorial data on one or more of the regions, such as described above. In embodiments, the virtual map may be again evaluated for gaps or for regions requiring data supplementation, and additional requests generated for additional pictorial data. The received pictorial data may include supplemental data, such as text or voice commentary, and may be provided by an application program on a mobile device. The method continues with evaluating the virtual pictorial mapping, including pictorial data, if any, received in response to one or more requests, to issue an insurance based action instruction, step 680, or to form an insurance recommendation. Evaluation may include evaluating the catastrophe scene for damage to assess risk to insurance company personnel as well as reviewing the insured properties to determine claim advances to insured, etc. By way of example, the evaluating to assess risk to insurance company personnel may include applying photo analysis algorithms to detect fires, such as by hot spots in infrared data included in images, patterns characteristic of smoke against sky or other backgrounds, patterns characteristic of downed utility poles, downed electrical wires, trees, utility poles and other objects blocking streets, by way of example. The insurance based action instruction may include instructions to insurance company personnel to perform on site evaluation of an insured property, to exercise caution or use particular devices or equipment in a region or at or near an insured property.

Evaluation to review insured properties to determine claim advances may include comparisons of image data of insured properties after a catastrophe to earlier data to determine extent of changes indicating damage, comparisons of image data to one or more characteristic elements indicative of damage to walls, roofs and other features, by way of example. In embodiments, the system may be configured to provide insurance company personnel with displays of photos, policy information and response options such as notification of alerts as to dangers or determinations of claim advances. For example, identified images of standing water in photographs, or text data including wording such as “flooding,” may cause notification of flood danger or recommendations for use of sport utility vehicles or other high clearance vehicles. The method continues with transmitting the insurance based action instruction or insurance recommendation to an insurance entity server, step 690. The insurance based action instruction or recommendation may include an electronic communication to a claims staffing center to provide a claim advance or an assignment of claims personnel to the geographic location for adjustment or other assessment and/or a communication to an insured with insured property status data such as an alert as to the damage to their property, and/or instructions as to submission of a claim. Data to an insurance entity system may include a recommendation as to a number of claims personnel to be assigned to a region or sub-region; the recommendation may be based on algorithms or tables associating numbers of insured properties, numbers of damaged properties detected, estimated numbers of damaged insured properties in a region based on a fraction or percentage of insured properties for which pictorial data is available having damage, and numbers of claims personnel appropriate for a given number of damaged insured properties.

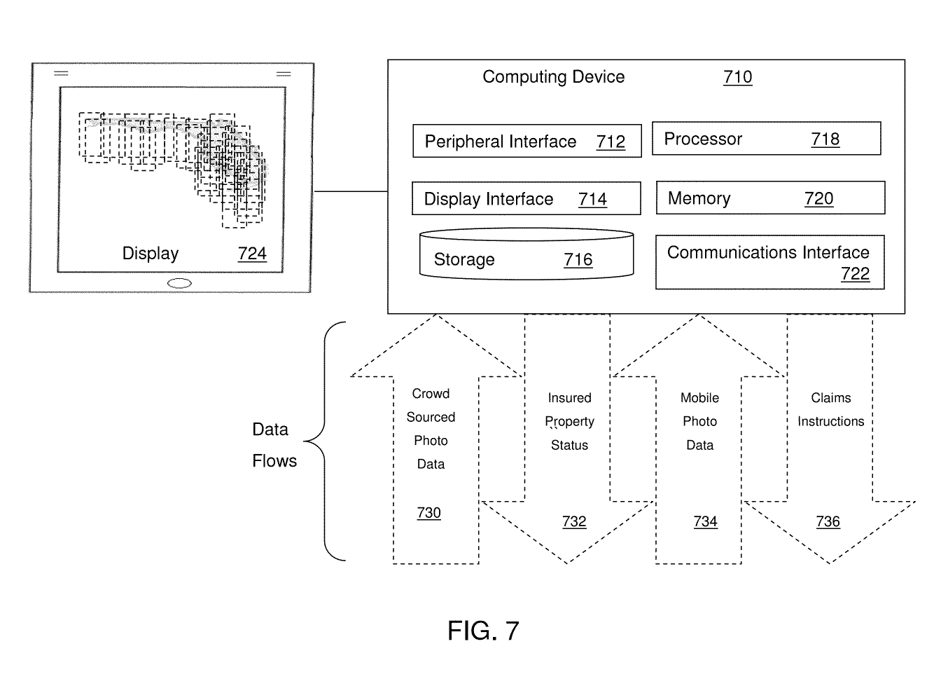

FIG. 7 shows an example computing device 710 that may be used to implement features describe above for managing catastrophe related data in accordance with the present invention. The computing device 710 may include a peripheral device interface 712, display device interface 714, a storage device 716, a processor 718, a memory device 720, and a communication interface 722. Computing device 710 may be coupled to a display device 724, which may be separately coupled to or included within the computing device 710. In operation, computing device 710 is configured to receive and transmit a number of data flows via communications interface 722 including, for example, crowd sourced photo data 730 as from a variety of social network sites, insured property status 732 such as property damage status to claimants, mobile photo data 734 such as from third party entities and claims instructions 736 such as internal insurance entity staffing and payment data.

The peripheral device interface 712 may be an interface configured to communicate with one or more peripheral devices. The peripheral device interface 712 may operate using a technology such as Universal Serial Bus (USB), PS/2, Bluetooth, infrared, serial port, parallel port, and/or other appropriate technology. The peripheral device interface 712 may, for example, receive input data from an input device such as a keyboard, a mouse, a trackball, a touch screen, a touch pad, a stylus pad, and/or other device. Alternatively or additionally, the peripheral device interface 712 may communicate output data to a printer that is attached to the computing device 710 via the peripheral device interface 712.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 710.

The memory device 720 of FIG. 7 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

An instance of the computing device 710 of FIG. 7 may be configured to perform any feature or any combination of features described above as performed by user devices 132a-n and 132 as described with respect to FIG. 1. In such an instance, the memory device 720 and/or the storage device 716 may store instructions which, when executed by the processor 718, cause the processor 718 to perform any feature or any combination of features described above as performed by the web browser module 134. Alternatively or additionally, in such an instance, each or any of the features described above as performed by the web browser module 134 may be performed by the processor 718 in conjunction with peripheral device interface 712, display device interface 714, and/or storage device 716, memory device 720, and communication interface 722.

Alternatively or additionally, an instance of the computing device 710 may be configured to perform any feature or any combination of features described above as performed by the insurance data system 110. In such an instance, the memory device 720 and/or the storage device 716 may store instructions which, when executed by the processor 718, cause the processor 718 to perform any feature or any combination of features described above as performed by the interface module 112 and/or the business rules module 114. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the web site system 120. In such an instance, the memory device 720 and/or the storage device 716 may store instructions which, when executed by the processor 718, cause the processor 718 to perform any feature or any combination of features described above as performed by the web application module 122 and/or the HTTP server module 124. In such an instance, the processor 718 may perform the feature or combination of features in conjunction with the memory device 720, communication interface 722, peripheral device interface 712, display device interface 714, and/or storage device 716.

Although FIG. 7 shows that the computing device 710 includes a single processor 718, single memory device 720, single communication interface 722, single peripheral device interface 712, single display device interface 714, and single storage device 716, the computing device may include multiples of each or any combination of these components 712, 714, 716, 718, 720, and 722 and may be configured to perform analogous functionality to that described above.

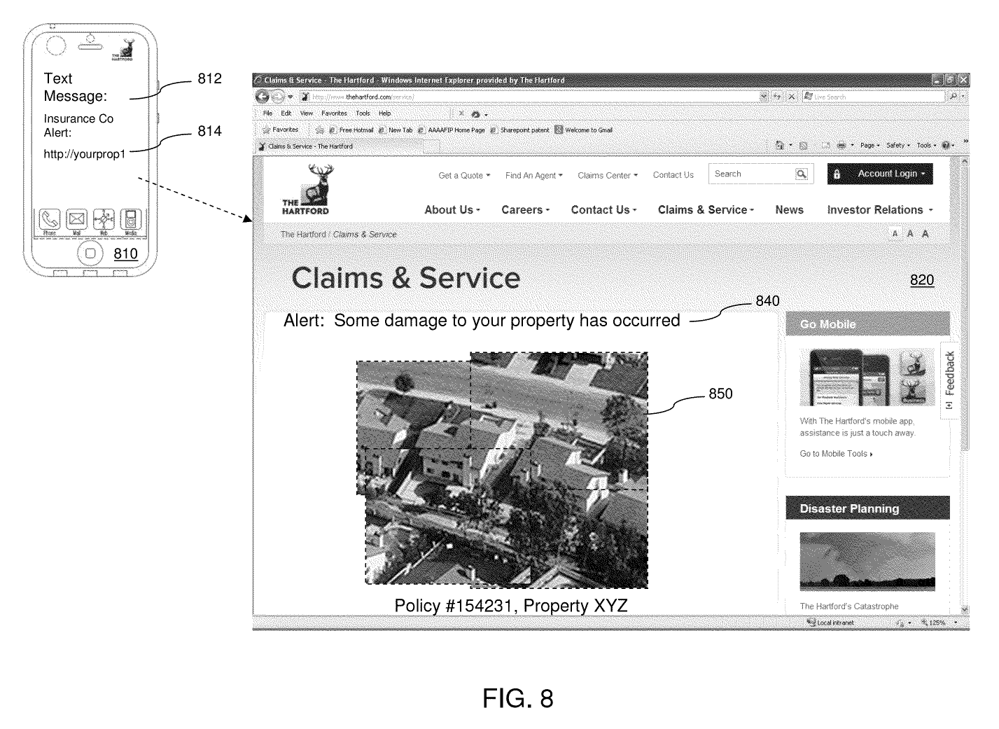

FIG. 8 shows an example of a system operation and associated graphical user interfaces according to the present invention which may be displayed on a display screen of a mobile device 810 and an associated web page 820. In operation, the present invention may provide insureds with alerts as to catastrophes affecting their property. Such an alert system may include mobile device 810 that is configured to display an insurance based alert message 812 that may be sent to an insured by an insurance entity. The insurance based alert message 812 may contain information related to the insured's property such as a link 814 containing additional information about the insured's property affected by the catastrophe. Link 814 may provide additional information to the insured such as screen 820 with an insurance based alert message 840 regarding the insured's property and a photograph 850 that is compiled in accordance with an embodiment of the present invention.

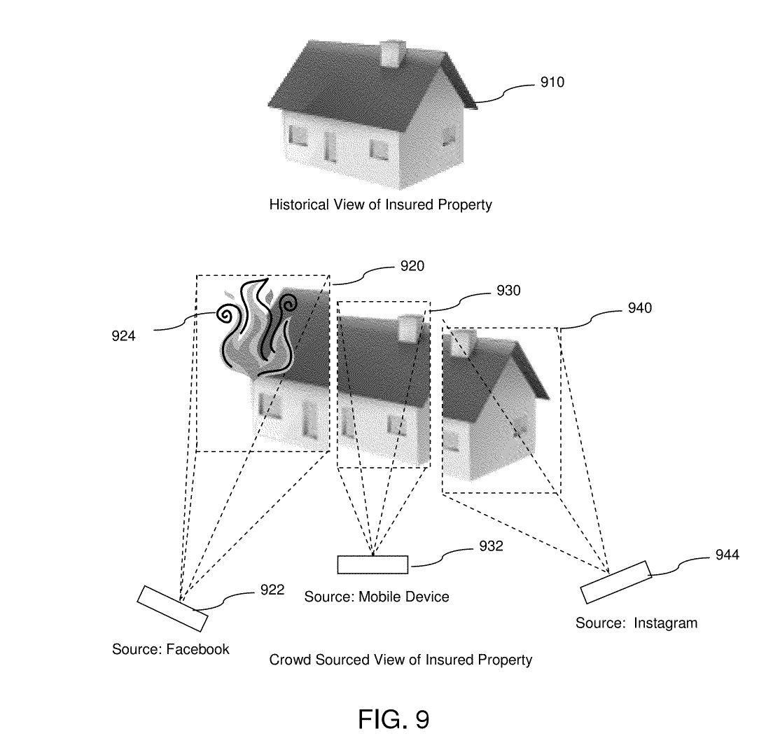

Referring to FIG. 9, an exemplary layout of a virtual mapping is shown that may be employed in the present invention. In operation, an insurance entity may store one or more historical images of an insured property such as image 910. Upon occurrence of a catastrophic event or at some periodic interval in time, a crowd sourced view of the insured property may be created utilizing a series of images such as images 920, 920 and 940. Images 920, 920 and 940 may originate from one or more sources including a crowd sourced site 922, a mobile device 932 or another crowd sourced site 944. Images 920, 920 and 940 may be aggregated together to form a real time view of the insured property and any associated damage 924.

The present invention has a number of benefits including allowing for the gathering of more data more quickly from multiple sources during a time where speed of response is the most important factor. Utilizing the present invention a number of process and substantive areas are improved including: customer service and claims response; resource and capital allocation; proactive customer alerts; and information on exposure of the realized risk event to insurance company stakeholders. The present invention can automate the intelligence gathering, such that skilled/trained claims insurance personnel can focus on executing to provide customers with the best service possible during a very difficult time.

Although the methods and features described above with reference to FIGS. 1-8 are described above as performed using the example architecture 100 of FIG. 1 and the exemplary system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described with reference to FIGS. 1-8 may be used alone without the other features and elements or in various combinations with or without other features and elements. Sub-elements of the methods and features described above with reference to FIGS. 1-8 may be performed in any arbitrary order (including concurrently), in any combination or sub-combination.

What is claimed is:

1. A system for intelligently compiling and assessing pictorial based data for insurance claims operations, the system comprising:
at least one processor;
a memory coupled to the at least one processor;
and one or more programs, wherein the one or more programs are stored in the memory and configured to be executed by the at least one processor, the one or more programs including instructions for:
segmenting a selected geographic location into a plurality of regions to form a virtual pictorial mapping of one or more insured properties;
accessing crowd sourced based pictorial data for each of the plurality of regions;
compiling the crowd sourced based pictorial data into the virtual mapping by correlating location based information associated with the pictorial data to the virtual mapping;
determining if one or more gaps exist within the virtual mapping;
accessing pictorial data for the one or more gaps;
associating the accessed pictorial data to the one or more gaps;
evaluating the virtual mapping to determine an insurance based action instruction; and
issuing a communication via an insurance claims system related to the evaluation of the virtual mapping.

2. The system of claim 1, wherein the crowd sourced based pictorial data comprises GIS meta-data associated with a social network based digital image.

3. The system of claim 1, wherein accessing pictorial data for the one or more gaps comprises issuing instructions related to a geographical location corresponding to at least one region to one or more users.

4. The system of claim 1, wherein the instructions further comprise instructions for sending out an alert to an insured related to an insured property.

5. The system of claim 4, wherein the alert includes pictorial data related to the insured property.

6. The system of claim 1, wherein the location based information includes using one of a global positioning coordinate, an IP Address or a cell tower triangulation.

7. The system of claim 1, wherein correlating location based information associated with the pictorial data to the virtual mapping comprises analyzing content of the pictorial data.

8. The system of claim 1 wherein the communication to an insurance claims system related to the evaluation of the virtual mapping includes an assignment of claims personnel to the geographic location.

9. The system of claim 1 wherein the virtual pictorial mapping includes at least one utility map overlay.

10. The system of claim 1, wherein compiling the crowd sourced based pictorial data into the virtual mapping includes parsing text associated with the pictorial data.

11. The system of claim 1, wherein the crowd sourced based pictorial data comprises pictures from a plurality of social network sites.

12. The system of claim 11, wherein the crowd sourced based pictorial data is augmented with satellite based imagery.

13. The system of claim 1, wherein associating the requested pictorial data to the one or more gaps comprises overlaying the requested pictorial data to one or more regions.

14. The system of claim 1, wherein issuing a communication via an insurance claims system comprises payment instructions for claim advances to insureds.

15. A computer program, comprising a computer usable medium having a computer readable program code embodied therein, said computer readable program code adapted to be executed to implement a method for assessing catastrophe damage in an afflicted geographic area, said method comprising:
dividing an area into a plurality of photo regions to form a virtual area map;
receiving crowd sourced digital images;
assigning the digital images to one or more regions on the virtual area map;
determining if one or more regions require data supplementation;
acquiring additional image data for the regions requiring data supplementation;
evaluating the virtual area map to form an insurance recommendation; and
transmitting data to an insurance entity system related to the insurance recommendation.

16. The system of claim 15, wherein the insurance recommendation is a number of claims personnel for assignment to the afflicted geographic area.

17. The system of claim 15, wherein acquiring additional image data for the regions requiring data supplementation comprises communicating with one or more phone based apps.

18. A computer-implemented method for intelligent automated catastrophe site evaluation comprising:
arranging a selected geographic location into a plurality of regions to form a virtual pictorial mapping;
accessing crowd sourced based pictorial data for each of the plurality of regions;
compiling the crowd sourced based pictorial data into the virtual mapping by correlating location based information associated with the pictorial data to the virtual mapping;
determining if one or more gaps exist within the virtual mapping;
requesting pictorial data for the one or more gaps;
associating the requested pictorial data to the one or more gaps;
evaluating the virtual mapping to issue an insurance based alert message; and
transmitting the alert message to a policyholder device.

19. The computer-implemented method of claim 18, wherein the crowd sourced based pictorial data is periodically collected and time stamped to form a real time virtual mapping that can be compared to determine if any damage has occurred to one or more insured properties.

20. The computer-implemented method of claim 18, wherein the crowd sourced based pictorial data is acquired from two or more social network sources.
